(19) United States
(12) Patent Application Publication
(10) Pub. No.: US 2024/0391331 A1
(43) Pub. Date: Nov. 28, 2024

(54) TESLA

(71) Applicant: Terence Emery Ducre, Westwego, LA (US)

(72) Inventor: Terence Emery Ducre, Westwego, LA (US)

(21) Appl. No.: 18/831,057

(22) Filed: May 24, 2024

Related U.S. Application Data
(60) Provisional application No. 63/630,519, filed on Feb. 12, 2024.

(51) Int. Cl. B60L 53/10

(52) U.S. Cl. CPC B60L 53/10

(57) ABSTRACT

TESLA was named after my birth name TERENCE EMERY SANDERS and the LA is because I'm from Louisiana. I graduated from ITT technical institute located in Saint Rose, Louisiana, with a degree in electronics engineering in 2002. As a kid, THE TESLA epiphany was brought to me by the charging of a cell phone and a smoky exhaust of a white pickup vehicle. This white pickup vehicle got me sick almost immediately after passing me by as a child from the leaky exhaust. However, this is how I thought of Dual Motor working electronically without gas on all circuits. Note: The charging of my mother's Motorola brick cell phone gave me the idea in the early 90's of AC to DC.

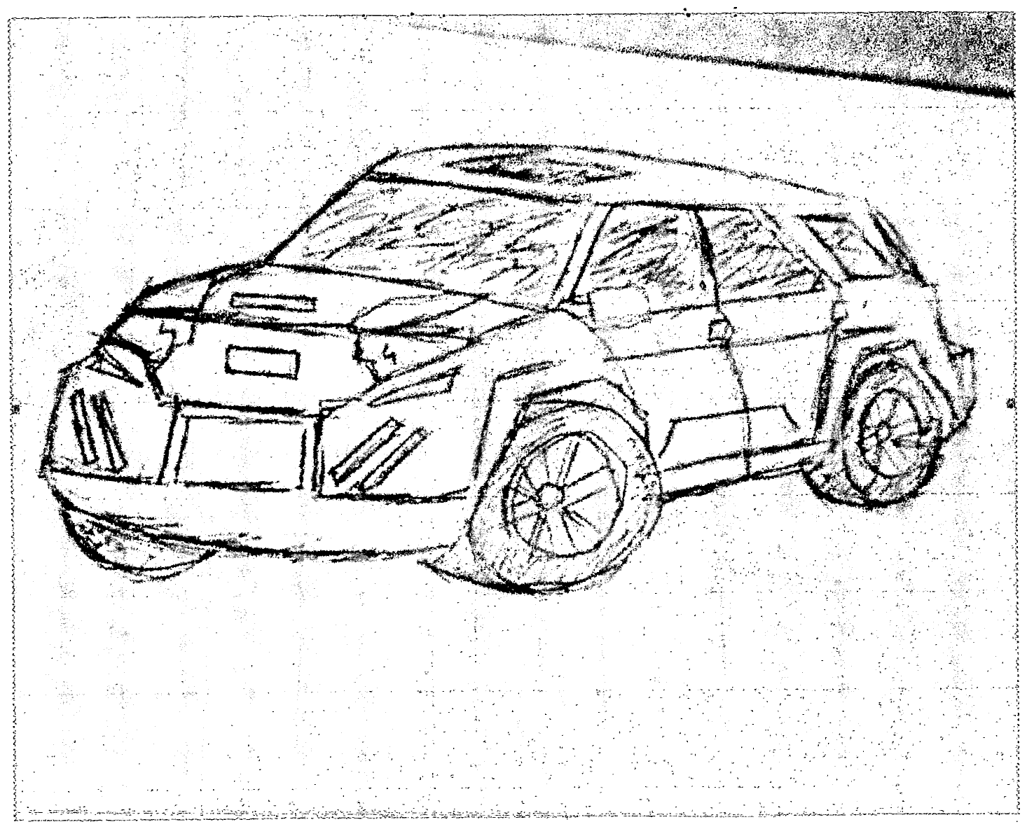

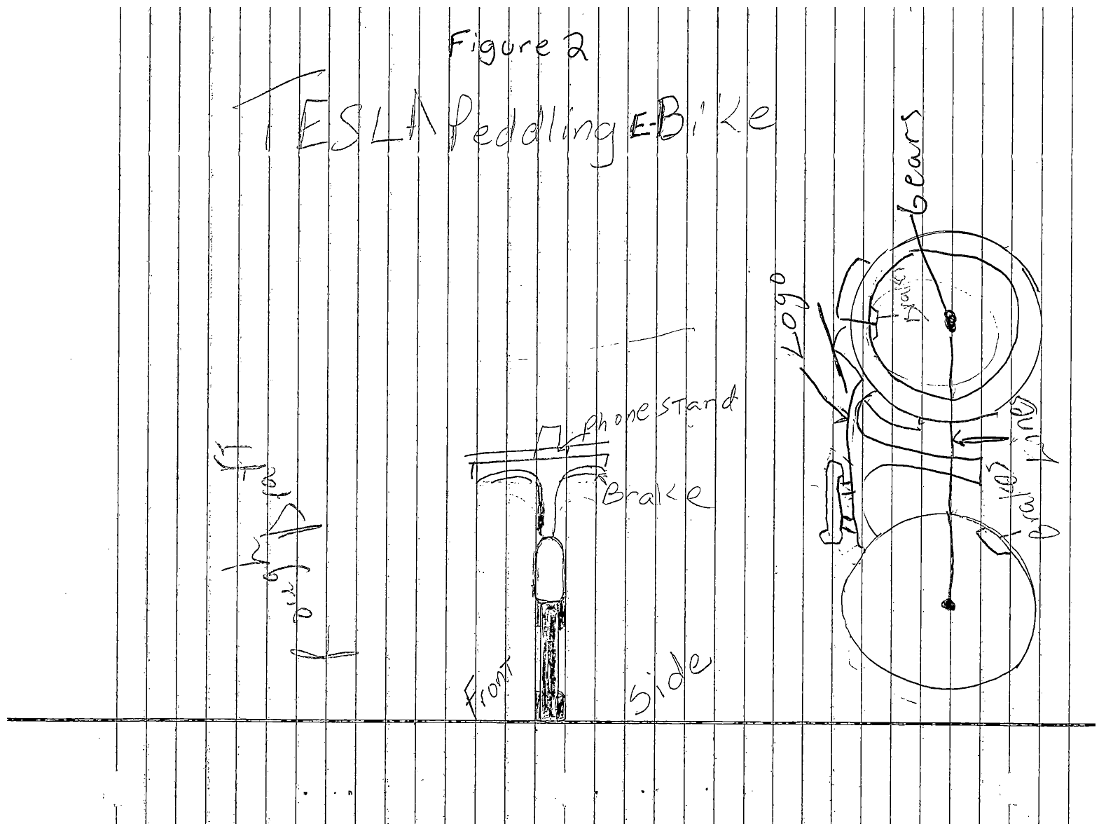

TESLA was named after my birth name TERENCE EMERY SANDERS, and the LA is because I was born in Louisiana.

I am an Electronic Engineer that graduated from ITT technical institute in Saint Rose, LA.

As a kid, THE TESLA epiphany was brought to me by the charging of a cell phone and a smoky exhaust of a white pickup vehicle.

This white pickup vehicle got me sick almost immediately after passing me by as a child from the leaky exhaust. All this was happening while I was walking switching the batteries around in my Walkman CD player to get power.

My mother's maiden name is Norfleet so by implication of the letter N. My alias name is TEN. So I thought if I converted the letter X to a Roman numeral this would bring swag to our Digital age as Space X to join up with NASA and provide security of my dream TESLA to become of existence as the first ELECTRONIC VEHICLE.

I thought by using Dual motors would balance out the load of the vehicle.

In relation of my theory I wanted to believe by recycling reusable energy would help our planet and ozone layer by protecting carbon dioxide from polluting the Greenhouse effect.

P.S. By completing this process of ownership we can move forward in our business as planned to change the world one “Vehicle” at a time.

1. is the name of the vehicle, which is Tesla, and its purpose to be zero emissions vehicle.

2. is the mechanics of how the vehicle charges similar to a cellular phone.

3. claim is the name specified on the back of the electronic vehicle Dual Motor as in reference to how the vehicle operates on circuit.
